(19) United States
(12) Patent Application Publication
(10) Pub. No.: US 2025/0322003 A1
(43) Pub. Date: Oct. 16, 2025

(54) INFORMATION PROCESSING DEVICE, INFORMATION PROCESSING METHOD, INFORMATION PROCESSING PROGRAM, AND TERMINAL DEVICE

(71) Applicant: SONY GROUP CORPORATION, TOKYO (JP)

(72) Inventors: SHIMENG PENG, TOKYO (JP); HIRO IWASE, TOKYO (JP); KENJI MORITA, TOKYO (JP); HARUKA KUTSUKI, TOKYO (JP)

(21) Appl. No.: 18/866,160

(22) PCT Filed: May 16, 2023
(86) PCT No.: PCT/JP2023/018196

§ 371 Date: Nov. 15, 2024

(30) Foreign Application Priority Data
May 25, 2022 (JP) 2022-085133

(51) Int. Cl. G06F 16/335; G06F 3/01

(52) U.S. Cl. CPC G06F 16/337; G06F 3/011; G06F 3/016

(57) ABSTRACT

An information processing device according to an embodiment includes: an estimation part that estimates, on the basis of context information of a first user, a fan type to which a second user belongs among fan types that are types defined for each of predetermined targets, and are types defined in stages according to degrees of supporting the predetermined target; and a control unit that executes, for the second user, control according to a fan type estimated by the estimation part.

### FIELD

The present disclosure relates to an information processing device, an information processing method, an information processing program, and a terminal device.

### BACKGROUND

A technique for realizing communication using tactile stimulus has been provided (e.g., Patent Literature 1).

### CITATION LIST

### Patent Literature

Patent Literature 1: Japanese Patent No. 6835070

### SUMMARY

### Technical Problem

However, the related art may not always improve a fan experience. For example, the related art aims at enhancing a sense of unity and communication between an artist and an audience or between audiences by generating a tactile signal from biological information sensed from a certain person, and transmitting the tactile signal to other person.

For this reason, the related art does not take into consideration a fan attribute such as how much an audience is a fan with respect to which target (e.g., a player, a team, or the like participating in an event), and cannot always improve a fan experience.

Therefore, the present disclosure proposes an information processing device, an information processing method, an information processing program, and a terminal device that enable improvement of a fan experience of a user.

In order to solve the above problems, one aspect of an information processing device according to the present disclosure includes an estimation part that estimates, on the basis of context information of a first user, a fan type to which a second user belongs among fan types that are types defined for each of predetermined targets, and are types defined in stages according to degrees of supporting the predetermined target; and a control unit that executes, for the second user, control according to a fan type estimated by the estimation part.

### BRIEF DESCRIPTION OF DRAWINGS

FIG. 1 is a diagram for explaining an overview of information processing according to an embodiment.

FIG. 2 is a flowchart illustrating an overall flow of a procedure of the information processing according to the embodiment.

FIG. 3 is a diagram illustrating a configuration example of an information processing device according to the embodiment.

FIG. 4 is a conceptual diagram of a data structure in a profile information database.

FIG. 5 is a diagram illustrating an example of a learning information database according to the embodiment.

FIG. 6 is a diagram illustrating a configuration example of a terminal device according to the embodiment.

FIG. 7 is a flowchart illustrating a procedure of generation processing for generating a classification model.

FIG. 8 is a flowchart illustrating a procedure of estimation processing for estimating a fan attribute.

FIG. 9 is a diagram illustrating an example of a method of estimating a fan attribute from an output result by the classification model.

FIG. 10 is a diagram illustrating an example (1) of an associating method.

FIG. 11 is a diagram illustrating an example (2) of the associating method.

FIG. 12 is a diagram illustrating an example (3) of the associating method.

FIG. 13 is a flowchart (1) illustrating a procedure of fanization promotion processing according to the embodiment.

FIG. 14 is a flowchart (2) illustrating a procedure of the fanization promotion processing according to the embodiment.

FIG. 15 is a flowchart illustrating a procedure of fan experience improvement processing.

FIG. 16 is a block diagram illustrating a hardware configuration example of a computer corresponding to a device according to the embodiment of the present disclosure.

### DESCRIPTION OF EMBODIMENT

In the following, an embodiment of the present disclosure will be described in detail with reference to the drawings. Note that an information processing device, an information processing method, an information processing program, and a terminal device according to the present disclosure are not limited to the embodiment. In the following embodiment, the same parts are denoted by the same reference numerals to omit redundant description.

### Embodiment

### 1. Introduction

For example, in a situation of viewing an event such as a sports game or a concert, controlling information to be provided according to a fan attribute is an important means for improving a fan experience.

However, although there exists a technique for enhancing a sense of unity and communication in an event venue as in the above-described related art, the technique does not take into consideration a fan attribute of an audience, and there is room for improvement in the related art in terms of controlling information to be provided according to a fan attribute.

In addition, in order to entertain a new audience who is yet to become an official fan with a content, giving an appropriate stimulus is considered to be required. However, since a way of enjoyment greatly depends on an individual content, analysis of the content is required. However, it is not easy to analyze a content and reflect an analysis result on an audience.

Therefore, the information processing device according to a proposed technique of the present disclosure utilizes various types of context information regarding a user, estimates to which one of fan attributes the user corresponds, and separately outputs information according to an estimation result. In addition, the information processing device also realizes fanization rearing support service for new fans and loyalty enhancement support service for fans.

Such an information processing device enables a fan experience of a user to be improved. Furthermore, a general-purpose method of conveying how to enjoy a content to a person who is not familiar with the content is realized, and for example, it is possible to support an organizer or a sponsor of a competition so as to have more new fans.

### 2. Fan Attribute

Next, a fan attribute according to the embodiment will be described. The fan attribute corresponds to a type defined in stages according to a degree of support. More specifically, the fan attribute corresponds to a fan type that is a type defined for each predetermined target and is a type defined in stages according to a degree of supporting the predetermined target.

In addition, the fan type is divided into a first fan type indicating being an official fan of any of the predetermined targets, a second fan type indicating being a potential fan of any of the predetermined targets, and a third fan type indicating not being any fan of any of the predetermined targets.

For this reason, in the following embodiment, a fan attribute corresponding to the first fan type is referred to as “official fan”, and a user belonging to “official fan” is referred to as “official fan user”. A fan attribute corresponding to the second fan type is referred to as “potential fan”, and a user belonging to “potential fan” is referred to as “potential fan user”. A fan attribute corresponding to the third fan type is referred to as “non-fan”, and a user belonging to “non-fan” is referred to as “non-fan user”.

Furthermore, a predetermined target here may be a person or a group (event participant) who entertains an audience in an event such as a sports game or a concert, and examples thereof include players, artists, teams, and groups. Therefore, an information processing device 100 may estimate, for example, an “official fan” of a “player P1”, a “potential fan” of a “team T1”, and the like as a fan attribute of a certain user.

### 3. System Configuration

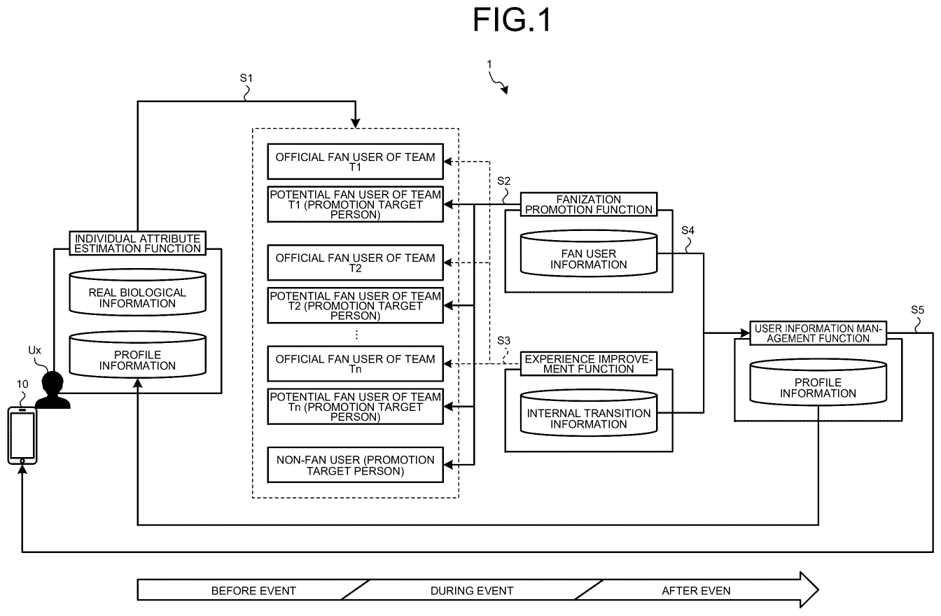

Next, a configuration of a system according to the embodiment will be described with reference to FIG. 1. FIG. 1 is a diagram for explaining an overview of information processing according to the embodiment. FIG. 1 illustrates a system 1 as an example of a system according to the embodiment. The system 1 can be applied, for example, in an event venue where an event such as a sports game or a concert is held. As an example, the system 1 is preferably applied to an event in which a user as an audience can be classified into any one of an “official fan”, a “potential fan”, and a “non-fan” in a situation where there are a plurality of persons or groups on the side of entertaining the audience.

As illustrated in FIG. 1, the system 1 may include a terminal device 10 and the information processing device 100. Furthermore, the terminal device 10 and the information processing device 100 may be connected to communicate with each other in a wired or wireless manner via a network N.

The information processing device 100 is an example of the information processing device according to the proposed technique of the present disclosure, and is a main device that performs information processing according to the embodiment.

The terminal device 10 is an information processing terminal for use by a user, and examples thereof include a smartphone, a tablet terminal, a notebook personal computer (PC), a desktop PC, a mobile phone, and a personal digital assistant (PDA).

For example, predetermined application software (terminal program) that realizes transmission and reception of information to and from the information processing device 100 may be introduced into the terminal device 10. Furthermore, such application software may be general-purpose application software such as a web browser, or may be implemented as dedicated application software corresponding to the information processing device 100.

Here, according to the system 1, the terminal device 10 can be said to be an edge computer that performs edge processing near a user. On the other hand, the information processing device 100 may be, for example, a cloud computer that performs processing on a cloud side, i.e., a server device.

### 4. Overview of Information Processing According to Embodiment

Next, an overall picture of the information processing according to the embodiment will be described with reference to FIG. 1. The information processing according to the embodiment is realized between the terminal device 10 and the information processing device 100 in the system 1.

As illustrated in FIG. 1, functions of the information processing device 100 are roughly divided into four functions, an individual attribute estimation function, a fanization promotion function, an experience improvement function, and a user information pipeline function, so that information processing according to each function is realized. Furthermore, FIG. 1 illustrates a scene in which information processing according to these functions is performed for an arbitrary user Ux participating as an audience in an event EV to which the system 1 is applied. Although in the description of the embodiment, the event EV is a baseball game, a content of the event EV is not limited to such an example.

According to the example of FIG. 1, the information processing device 100 estimates a fan attribute of the user Ux by the individual estimation function (Step S1), and controls a potential fan user and a non-fan user among the users Ux to make an attribute transition to an official fan by the fanization promotion function (Step S2). The information processing device 100 also performs control for adding a value to an experience of the user whose attribute change has been detected by the experience improvement function among the users Ux (Step S3).

Furthermore, the information processing device 100 analyzes a characteristic of the user Ux by the user information management function, and provides a content according to the analysis result (Step S4).

In addition, as illustrated in FIG. 1, Steps S1 to S3 may be executed from before the event EV is held (e.g., a predetermined time before the venue time) to during the event EV, and Step S4 may be executed after the end of the event EV.

In the following, each function will be described in more detail. First, the individual attribute estimation function in Step S1 will be described. The information processing device 100 estimates a fan attribute of the user Ux on the basis of biological information sensed in real time and profile information as context information of the user Ux. For example, the information processing device 100 generates a classification model using a combination of label information obtained by analyzing the profile information and the biological information as learning data, and estimates a fan attribute of the user Ux using the generated classification model. Details will be described later.

FIG. 1 illustrates an example in which for the user Ux, the information processing device 100 estimates “team T1/official fan”, “team T1/potential fan”, “team T2/official fan”, “team T2/potential fan”, “non-fan”, and the like as a fan attribute (team Tn/fan attribute) targeting a team In. In other words, the example is illustrated in which the information processing device 100 classifies each of the users Ux who are audiences of the event EV into any one of “team T1/official fan”, “team T1/potential fan”, “team T2/official fan”, “team T2/potential fan”, and “non-fan”.

Next, the fanization promotion function in Step S2 will be described. The information processing device 100 defines, among the users Ux, a user who is estimated to be a “potential fan” as a fan attribute, as a target person who is encouraged to make an attribute transition to the fan attribute “official fan”, i.e., as a promotion target person.

FIG. 1 illustrates the example in which the information processing device 100 defines, as promotion target persons, a potential fan user targeting the team T1 and a potential fan user targeting the team T2.

In such a state, the information processing device 100 associates an official fan user and the promotion target person, with the team In as a trigger. FIG. 1 illustrates the example in which the information processing device 100 associates an official fan user targeting the team T1 and a potential fan user targeting the team T1. Furthermore, FIG. 1 illustrates the example in which the information processing device 100 associates an official fan user targeting the team T2 and a potential fan user targeting the team T2.

Note that by defining, as the promotion target person, a non-fan user not targeting any team In (i.e., no target), the information processing device 100 may associate a specific user among the users Ux. This point will be described later.

Upon completion of the association as described above, the information processing device 100 performs control so that fanization promotion information, which is information for the purpose of encouraging an attribute transition to an “official fan”, is presented to the promotion target person.

According to the example of FIG. 1, the information processing device 100 generates, from biological information of an official fan user targeting the team T1, tactile information in which a physical condition of the user is reproduced, and transmits the tactile information to an output device worn by a potential fan user targeting the team T1. As a result, the potential fan user targeting the team T1 can feel a physical condition of the official fan user targeting the team T1, and thus a transition to the official fan is promoted.

Furthermore, according to the example of FIG. 1, the information processing device 100 generates, from biological information of an official fan user targeting the team T2, tactile information in which a physical condition of the user is reproduced, and transmits the tactile information to an output device worn by a potential fan user targeting the team T2. As a result, the potential fan user targeting the team T2 can feel a physical condition of the official fan user targeting the team T1, and thus a transition to the official fan is promoted.

Next, the experience improvement function in Step S3 will be described. The information processing device 100 may perform control so that additional information for the purpose of improving a fan experience in the event EV is presented to each of the users Ux regardless of which of the “official fan”, the “potential fan”, and the “non-fan” is estimated as a fan attribute.

For example, the information processing device 100 may repeatedly estimate a fan attribute when the event EV is being held. Therefore, the information processing device 100 detects whether or not the user Ux has made an attribute transition from a current fan attribute to other fan attribute. Then, in a case where the attribute transition has been detected, the information processing device 100 may perform control so that additional information for the purpose of adding a value to a fan experience of the user whose attribute transition has been detected is presented.

For example, in a case where there is a user who has made an attribute transition from a potential fan to an official fan (i.e., attribute up) among the users Ux, the information processing device 100 estimates a device (e.g., a penlight, a light emission wristband, or the like used in the event EV) owned by the user. Then, the information processing device 100 may control a light emission mode of the estimated device according to the attribute up. As an example, the information processing device 100 may increase a light emission intensity of the device according to the attribute up.

Furthermore, in a case where there is a user who has made an attribute transition from a potential fan to a non-fan (i.e., attribute down) among the users Ux, the information processing device 100 estimates a device owned by the user. Then, the information processing device 100 may control a light emission mode of the estimated device according to the attribute down. As an example, the information processing device 100 may decrease a light emission intensity of the device according to the attribute down.

Next, the user information management function in Steps S4 and S5 will be described. In Step S4, the information processing device 100 collects, as the profile information, fan user information indicating an official fan user among the users Ux, and internal transition information of the user Ux as a result of detection of an attribute transition such as an official fan from a potential fan, a non-fan from a potential fan, a potential fan from a non-fan, an official fan from a non-fan, a potential fan from an official fan, or a non-fan from an official fan, and analyzes a characteristic of the user Ux on the basis of the profile information. Furthermore, the information processing device 100 may analyze the characteristic of the user Ux by further using the biological information or history information (e.g., browsing history and purchase history) of the user Ux as the profile information.

For example, the information processing device 100 may analyze what kind of target and which type of the fan attribute the user Ux has as preference of the user Ux on the basis of the profile information. Furthermore, the information processing device 100 may analyze in which scene in the event EV emotion of the user Ux is evoked on the basis of a heart rate sensed as the biological information and a content browsing history.

Then, in Step S5, the information processing device 100 provides the user Ux with a content according to the analysis result. For example, the information processing device 100 can provide the user Ux with a content estimated to interest the user Ux as a recommended content. Furthermore, the information processing device 100 can provide the user Ux with a content estimated to appropriately interact with the emotion of the user Ux as a recommended content. For example, the information processing device 100 transmits such recommendation information to the terminal device 10 of the user Ux.

Furthermore, as illustrated in FIG. 1, the information processing device 100 may cycle the profile information reflecting the analysis result so as to be used in the individual attribute estimation function in Step S1.

### 5. Information Processing Procedure

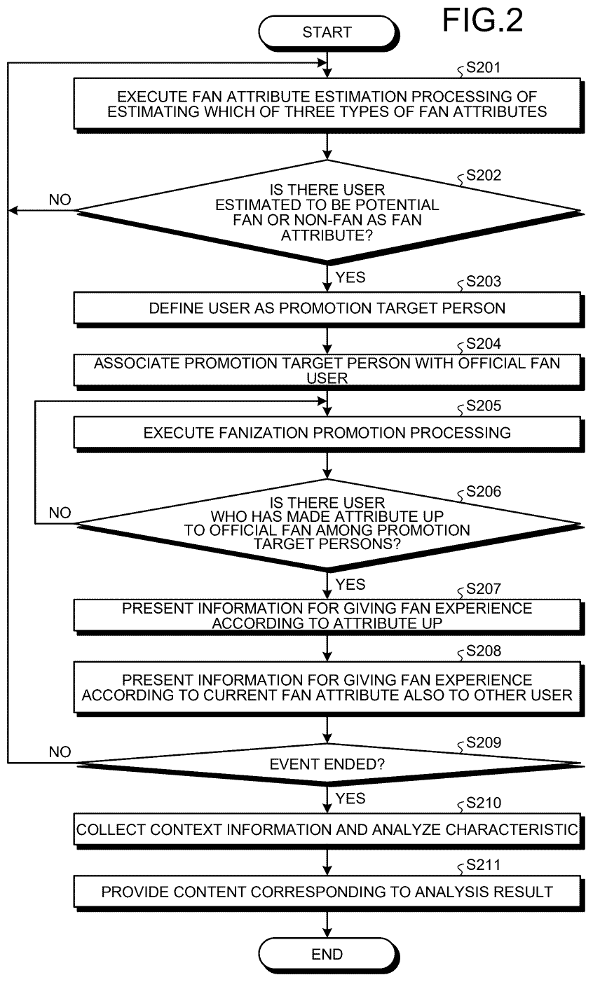

Next, a procedure of information processing realized among the individual attribute estimation function, the fanization promotion function, the experience improvement function, and the user information management function will be described with reference to FIG. 2. FIG. 2 is a flowchart illustrating an overall flow of the procedure of the information processing according to the embodiment.

First, the information processing device 100 executes fan attribute estimation processing of estimating which of the fan attributes of the three types (“official fan”, “potential fan”, and “non-fan”) defined for each predetermined target corresponds to each user Ux viewing the event EV (Step S201).

Next, on the basis of an estimation result, the information processing device 100 determines whether or not there is a user estimated to be a potential fan or a non-fan as a fan attribute among the users Ux (Step S202).

In a case where there is no user estimated to be a potential fan or a non-fan as the fan attribute (Step S202; No), the information processing device 100 repeats Step S201 until a user estimated to be a potential fan or a non-fan as a fan attribute appears.

On the other hand, in a case where there is a user estimated to be a potential fan or a non-fan as a fan attribute (Step S202; Yes), the information processing device 100 defines the user as a promotion target person who is encouraged to make an attribute transition to an official fan (Step S203). In other words, the information processing device 100 defines such a user as a promotion target person who is encouraged to make an attribute transition from a current fan attribute (potential fan or non-fan) to an official fan.

Next, the information processing device 100 executes association processing of associating the promotion target person with an official fan user (Step S204). For example, the information processing device 100 may associate, with the promotion target person, a user whose target (e.g., a baseball player or a baseball team who is a participant of the event EV.) is common to the promotion target person among the official fan users.

Subsequently, the information processing device 100 executes fanization promotion processing of performing control so that the fanization promotion information, which is information for the purpose of encouraging an attribute transition to an official fan, is presented to the promotion target person (Step S205). For example, the information processing device 100 generates, from biological information of an official fan user, tactile information in which a physical condition of the user is reproduced, and transmits the tactile information to an output device worn by the promotion target person.

In such a state, the information processing device 100 may detect whether or not the promotion target person has made an attribute transition from the current fan attribute to other fan attribute, and determine whether or not a user who has made an attribute transition to an official fan (attribute up) has appeared among the promotion target persons on the basis of the detection result (Step S206).

While a user who has made attribute up is yet to appear (Step S206; No), the information processing device 100 may repeat Step S205.

On the other hand, in a case where a user who has made attribute up appears among the promotion target persons (Step S206; Yes), the information processing device 100 presents information for giving a fan experience according to the attribute up to the user (Step S207).

Furthermore, the information processing device 100 may present information for giving a fan experience according to a current fan attribute also to a promotion target person having no attribute up or to an official fan user (Step S208).

In addition, in such a state, the information processing device 100 determines whether or not the event EV has ended (Step S209).

While the event EV is yet to be ended (Step S209; No), the information processing device 100 shifts the processing to Step S201.

On the other hand, in a case where the event EV has ended (Step S209; Yes), the information processing device 100 collects the context information of the user Ux, and analyzes the characteristic of the user Ux on the basis of the collected context information (Step S210). For example, the information processing device 100 may collect the profile information such as the fan user information, the internal transition information, the biological information, the history information, and the like, and analyze preference of the user Ux regarding the event EV, a scene acting on emotion of the user Ux in the event EV, and the like on the basis of the collected context information.

Then, the information processing device 100 provides a content according to the analysis result to each user Ux (Step S211). For example, the information processing device 100 provides a content according to the analysis result to the user Ux as a recommended content.

### 6. Configuration of Information Processing Device

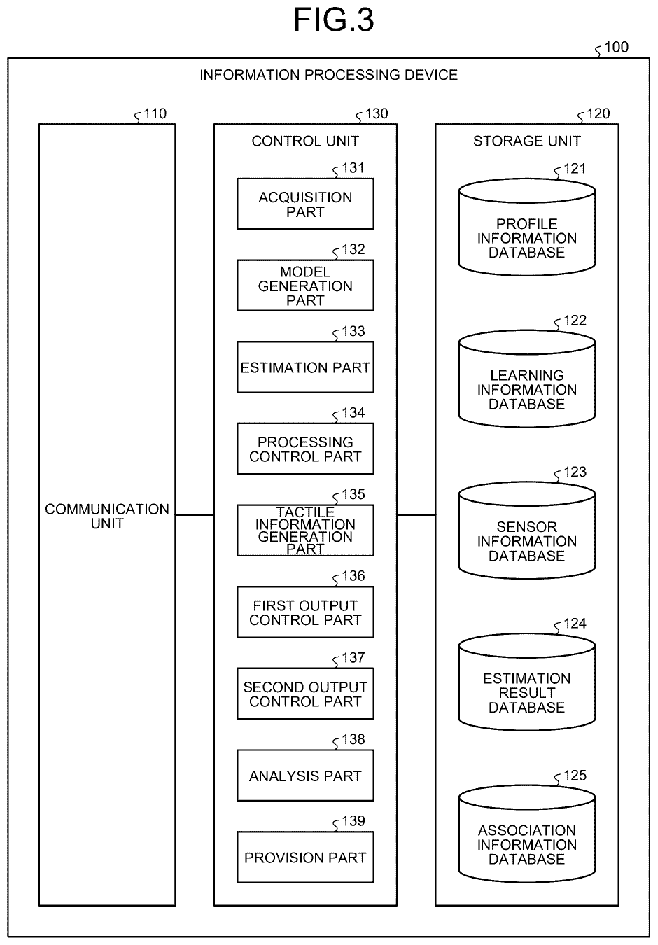

Next, the information processing device 100 according to the embodiment will be described with reference to FIG. 3. FIG. 3 is a diagram illustrating a configuration example of the information processing device 100 according to the embodiment. As illustrated in FIG. 3, the information processing device 100 includes a communication unit 110, a storage unit 120, and a control unit 130.

### (Communication Unit 110)

The communication unit 110 is realized by, for example, a network interface card (NIC) or the like. For example, the communication unit 110 is wirelessly connected to the network N, and transmits and receives information to and from the terminal device 10, for example.

### (Storage Unit 120)

The storage unit 120 is realized by, for example, a semiconductor memory element such as a random access memory (RAM) or a flash memory, or a storage device such as a hard disk or an optical disk. The storage unit 120 includes a profile information database 121, a learning information database 122, a sensor information database 123, an estimation result database 124, and an association information database 125.

### (Profile Information Database 121)

The profile information database 121 stores information regarding a context of a user as a profile of the user.

For example, the profile information database 121 may store the fan user information indicating an official fan user among the users Ux. In addition, the profile information database 121 may store, for the user Ux, the internal transition information regarding detection of an attribute transition such as an official fan from a potential fan, a non-fan from a potential fan, a potential fan from a non-fan, an official fan from a non-fan, a potential fan from an official fan, or a non-fan from an official fan. In addition, the profile information database 121 may store the biological information (e.g., heart rate, myoelectric potential, body temperature, temperature of palm, and the like) of the user Ux. In addition, the profile information database 121 may also store the history information (e.g., browsing history and purchase history) of the user Ux.

Furthermore, the profile information database 121 may also store an analysis result obtained by analyzing the characteristic of the user Ux on the basis of the above-described various types of context information. As an example, the profile information database 121 may store, as characteristics, preference such as what type of player, artist, team, group, or the like is preferred, and a mental state change situation such as in what scene in the event EV the emotion has been evoked.

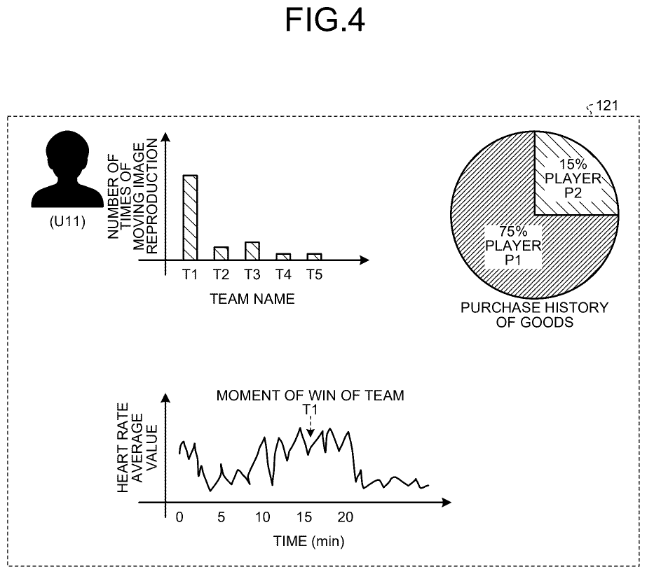

Here, FIG. 4 is a conceptual diagram of a data structure in the profile information database 121. FIG. 4 illustrates, as profile information of a user U11 (an example of the user Ux), temporal data indicating the number of times of moving image reproduction, a purchase history of goods, and a temporal change of a heart rate for each team Tn.

According to the example of FIG. 4, the information processing device 100 can estimate to which team the user U11 belongs as an official fan by analyzing the number of times of moving image reproduction and the temporal data. In addition, the information processing device 100 can estimate which player's official fan the user U11 is by analyzing a purchase history of goods.

### (Learning Information Database 122)

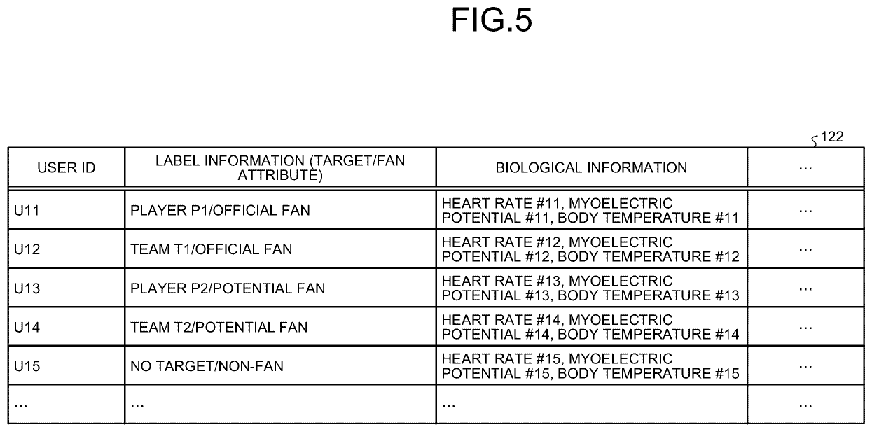

The learning information database 122 stores the learning data (training data) for use for learning a model. Here, FIG. 5 illustrates an example of the learning information database 122 according to the embodiment. In the example of FIG. 5, the learning information database 122 has items such as “user ID”, “label information”, and “biological information”. A combination of “label information” and “biological information” is used as the learning data.

The “user ID” is identification information for identifying a model user (a first user) defined to be a learning target among the users Ux.

The “label information” is a fan attribute estimated for a user indicated by the user ID, and is a fan attribute indicating to which target the user belongs as an official fan, indicating to which target the user belongs as a potential fan, or indicating that the user is a non-fan not belonging to any target, and is information for use as a correct answer label in the learning data.

FIG. 5 illustrates the example in which the user (user U11) indicated by the user “U11” and the label information “player P1/official fan” are associated with each other. Such an example illustrates an example in which an “official fan” targeting the player P1 is estimated as the fan attribute on the basis of the profile of the user U11. In other words, the example in which the user U11 is estimated to be an official fan user targeting the player P1 is illustrated.

The “biological information” is information indicating a result of sensing of a biological signal indicating emotion such as excitement or tension when the user indicated by the user ID views the event EV. The “biological information” may be temporal data indicating a temporal change in the heart rate due to continuous sensing of the heart rate from before to during the event EV. In addition, the “biological information” may be temporal data indicating a temporal change in the heart rate due to continuous sensing of the myoelectric potential from before to during the event EV. In addition, the “biological information” may be temporal data indicating a temporal change in the body temperature due to continuous sensing of the body temperature (e.g., a temperature of a palm) from before to during the event EV.

FIG. 5 illustrates the example in which the user (the user U11) indicated by the user “U11” is associated with the biological information “heart rate #11, myoelectric potential #11, body temperature #11”. Such an example shows an example in which as a result of sensing the heart rate of the user U11, the heart rate #11 is obtained as temporal data indicating a heart rate variation. In addition, such an example shows an example in which as a result of sensing the myoelectric potential of the user U11, the myoelectric potential #11 is obtained as temporal data indicating a variation of a myoelectric potential beat. In addition, such an example shows an example in which as a result of sensing the body temperature of the user U11, the body temperature #11 is obtained as temporal data indicating a variation of a body temperature.

### (Sensor Information Database 123)

The sensor information database 123 stores biological information sensed from before to during the event EV with respect to a user (a second user) defined to be an estimation target for which a fan attribute is to be estimated among the users Ux. The biological information here may be a heart rate, a myoelectric potential, or a body temperature.

### (Estimation Result Database 124)

The estimation result database 124 stores an estimation result of a fan attribute. For example, the estimation result database 124 may store time-series estimation results obtained by repeatedly estimating fan attributes from before to during the event EV.

### (Association Information Database 125)

The association information database 125 stores association information which associates an official fan user and a promotion target person with each other.

### (Control Unit 130)

The description returns to FIG. 3. As illustrated in FIG. 3, the control unit 130 is realized by, for example, a central processing unit (CPU), a micro processing unit (MPU), or the like executing various programs (e.g., an information processing program) stored in a storage device in the information processing device 100 using a RAM as a work area. In addition, the control unit 130 is realized by, for example, an integrated circuit such as an application specific integrated circuit (ASIC) or a field programmable gate array (FPGA).

As illustrated in FIG. 3, the control unit 130 includes an acquisition part 131, a model generation part 132, an estimation part 133, a processing control part 134, a tactile information generation part 135, a first output control part 136, a second output control part 137, an analysis part 138, and a provision part 139, and realizes or executes a function and an action of information processing to be described below. Note that an internal configuration of the control unit 130 is not limited to the configuration illustrated in FIG. 3, and may be any configuration that performs the information processing to be described later. In addition, a connection relationship of the processing parts included in the control unit 130 is not limited to the connection relationship illustrated in FIG. 3, and may be other connection relationship.

### (Acquisition Part 131)

The acquisition part 131 acquires information necessary for information processing according to the embodiment, and outputs the acquired information to a corresponding processing part. For example, the acquisition part 131 acquires biological information sensed for the user Ux. For example, the acquisition part 131 acquires biological information as sensor information detected by a sensor worn by the user Ux.

### (Model Generation Part 132)

The model generation part 132 generates a classification model for estimating a fan attribute of the second user on the basis of the learning data stored in the learning information database 122. For example, the model generation part 132 generates a classification model by using, as learning data, a combination of label information (fan attribute) applied to the first user and biological information detected from the first user.

For example, the model generation part 132 may generate a classification model that outputs, with respect to each fan attribute corresponding to each predetermined target, a probability that the second user belongs to the fan attribute by using the biological information of the second user as an input.

### (Estimation Part 133)

The estimation part 133 estimates, on the basis of the context information of the first user, a fan attribute to which the second user belongs among fan attributes that are types defined for each predetermined target and types defined in stages according to degrees of supporting the predetermined target. For example, the estimation part 133 estimates a fan attribute to which the second user belongs among the official fan, the potential fan, and the non-fan as a fan attribute defined for each predetermined target.

For example, the estimation part 133 estimates a fan attribute to which the second user belongs among the official fan, the potential fan, and the non-fan defined for each predetermined target on the basis of the classification model and the biological information of the second user. More specifically, the estimation part 133 estimates to which fan attribute of a target the second user belongs among the official fan, the potential fan, and the non-fan defined for each predetermined target on the basis of the probability output by inputting the biological information of the second user to the classification model.

### (Processing Control Part 134)

The processing control part 134 executes control corresponding to a fan attribute estimated by the estimation part 133 for the second user.

For example, in a case where there is a user estimated to be a potential fan as a fan attribute among the second users, the processing control part 134 defines the user as a promotion target person who is to be encouraged to make an attribute transition from the potential fan to the official fan. Then, among the second users estimated to be the official fan as a fan attribute, the processing control part 134 associates the official fan user who is a user whose target is common to that of the promotion target person with the promotion target person.

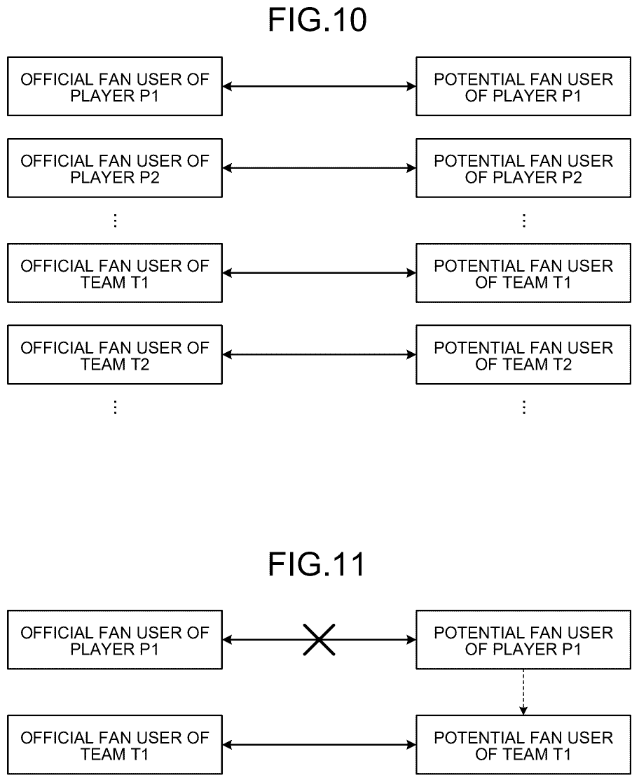

For example, in a case where there are a plurality of official fan users, the processing control part 134 may associate a user having the highest probability of being an official fan among the fan users with the promotion target person. An example of an associating method will be described with reference to FIG. 10.

Furthermore, in a case where there is no official fan user and association between an official fan user and the promotion target person is impossible, the processing control part 134 may redefine, as the promotion target person, a second user who has been estimated to be a potential fan as a fan attribute corresponding to high-order targets including a target indicated by the fan attribute of the promotion target person. An example of the associating method will be described with reference to FIG. 11.

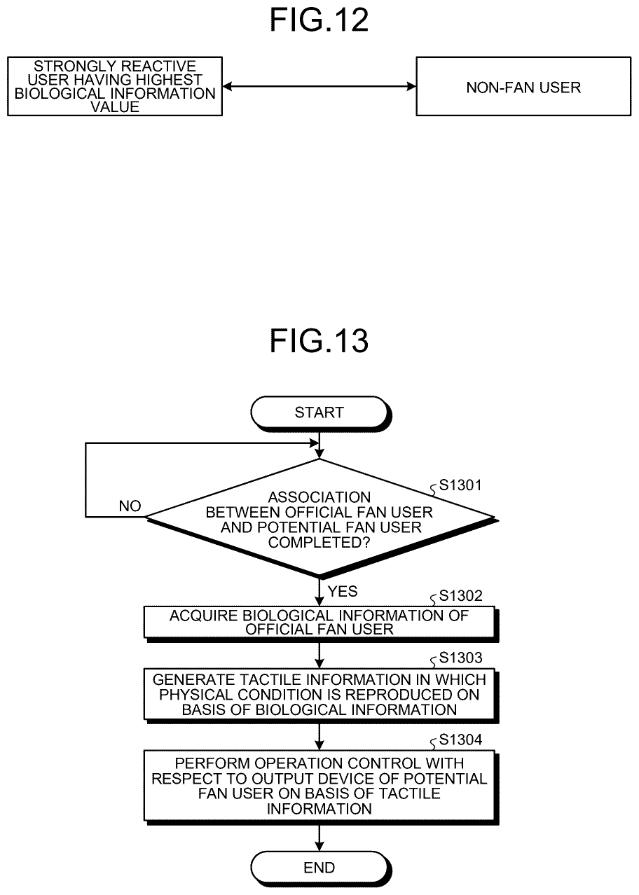

In addition, in a case where there is a user estimated to be a non-fan as the fan attribute among the second users, the processing control part 134 defines the user as the promotion target person who is encouraged to make an attribute transition from the non-fan to the official fan. Then, among the second users estimated to be official fans as a fan attribute, the processing control part 134 associates an official fan user who is a user detected to have the biological information having the highest value with the promotion target person. An example of the associating method will be described with reference to FIG. 12.

In addition, the processing control part 134 may perform control so that the fanization promotion information, which is information for the purpose of encouraging a transition of the fan attribute of the promotion target person to the official fan, is presented to the promotion target person. Furthermore, in a case where the attribute transition has been detected from the current fan attribute to other fan attribute by repeated estimation of a fan attribute, the processing control part 134 may perform control so that the additional information for the purpose of adding a value to an experience of a user whose attribute transition has been detected is presented.

### (Tactile Information Generation Part 135)

The tactile information generation part 135 generates tactile information indicating a physical condition of an official fan user associated with a promotion target person. Specifically, the tactile information generation part 135 generates tactile information in which a physical condition is reproduced on the basis of biological information detected from an official fan user.

For example, the tactile information generation part 135 may generate, as the tactile information, vibration information that causes a user to feel vibration corresponding to a heart rate variation of an official fan user. For example, the tactile information generation part 135 analyzes the temporal data indicating a temporal change of a heart rate of the official fan user, and extracts a heart rate variation pattern. Then, the tactile information generation part 135 generates a vibration waveform in which the heart rate variation pattern is reproduced, and generates vibration information on the basis of the generated vibration waveform. More specifically, the tactile information generation part 135 may calculate an RR interval as the heart rate variation pattern, and generate a vibration wave by processing a sine wave of, for example, 100 Hz using the RR interval.

Furthermore, the tactile information generation part 135 may generate, as the tactile information, pressure-sensitive information that causes a user to feel a pressure corresponding to a myoelectric potential of an official fan user. For example, the tactile information generation part 135 analyzes temporal data indicating a temporal change of a myoelectric potential of an official fan user, and estimates a contraction state of a wrist muscle by integrating an average amplitude. Then, the tactile information generation part 135 generates pressure-sensitive information in which the contraction state is reproduced.

In addition, the tactile information generation part 135 may generate, as the tactile information, thermal sensation information that causes a user to feel a body temperature of an official fan user. For example, the tactile information generation part 135 analyzes temporal data indicating a temporal change of a temperature of a palm of an official fan user, and calculates an average temperature. Then, the tactile information generation part 135 generates thermal sensation information in which the average temperature is reproduced. As another example, the tactile information generation part 135 may generate thermal sensation information on the basis of a temperature change detected from the temporal data. For example, the tactile information generation part 135 may generate thermal sensation information of a base temperature (e.g., 32° C.) +3° C. in a case where a temperature change of 1° C. has been detected, and generate thermal sensation information of a base temperature (e.g., 32° C.) +6° C. in a case where a temperature change of 2° C. has been detected.

### (First Output Control Part 136)

The first output control part 136 performs control so that the tactile information is output as the fanization promotion information from an output device worn by a promotion target person.

For example, in a case where the vibration information is generated by the tactile information generation part 135, the first output control part 136 performs control so that the output device worn by the promotion target person operates according to the vibration information. Note that in such an example, the output device worn by the promotion target person is preferably a device on which a vibration mechanism is mounted, and the first output control part 136 controls the vibration mechanism to vibrate according to the vibration information. As a result, the user can feel, in the entire his or her body, vibration in which excitement and tension of the official fan user are reproduced.

Furthermore, in a case where the pressure-sensitive information is generated by the tactile information generation part 135, the first output control part 136 performs control so that the output device worn by the promotion target person operates according to the pressure-sensitive information. Note that in such an example, the output device worn by the promotion target person is preferably a device mounted with a pump-type air pressure control mechanism, and the first output control part 136 controls the air pressure control mechanism so as to contract with an air pressure according to the pressure-sensitive information. In addition, a wristband-type device is suitable as a device on which a pump-type air pressure control mechanism is mounted. As a result, the user can sensitively feel a pressure in which excitement and tension of the official fan user are reproduced.

Furthermore, in a case where the thermal sensation information is generated by the tactile information generation part 135, the first output control part 136 performs control so that the output device worn by the promotion target person operates according to the thermal sensation information. Note that in such an example, the output device worn by the promotion target person is preferably a device with an element built-in that gives a thermal sensation stimulus, and the first output control part 136 controls the element so as to give a stimulus at a temperature corresponding to the thermal sensation information. In addition, a wristband-type device is suitable as a device with an element built-in that gives a thermal sensation stimulus. As a result, the user can sensitively feel a temperature at which excitement and tension of the official fan user are reproduced.

### (Second Output Control Part 137)

The second output control part 137 controls an output mode in a predetermined device corresponding to a user whose attribute transition has been detected according to the attribute transition. For example, the second output control part 137 estimates a device owned by the user Ux among the predetermined devices, and controls an output mode of the estimated device according to an attribute change.

### (Analysis Part 138)

The analysis part 138 analyzes a characteristic of a user on the basis of context information of the user. For example, the analysis part 138 analyzes the characteristic of the user Ux on the basis of the profile information such as the fan user information, the internal transition information, the biological information, the history information, and the like. For example, the analysis part 138 may analyze preference of the user Ux regarding the event EV, a scene acting on emotion of the user Ux in the event EV, and the like on the basis of the profile information. In addition, the analysis part 138 may also perform processing of estimating a fan attribute of the user Ux by analyzing the profile information, and generating learning data on the basis of a user estimated to be an official fan as a fan attribute.

### (Provision Part 139)

The provision part 139 provides a user with a content according to an analysis result obtained by the analysis part 138. For example, the provision part 139 may provide the user Ux with a content estimated to interest the user Ux as a recommended content. In addition, the provision part 139 may provide the user Ux with a content estimated to appropriately interact with emotion of the user Ux as a recommended content. For example, the provision part 139 transmits such recommendation information to the terminal device 10 of the user Ux.

### 7. Configuration of Terminal Device

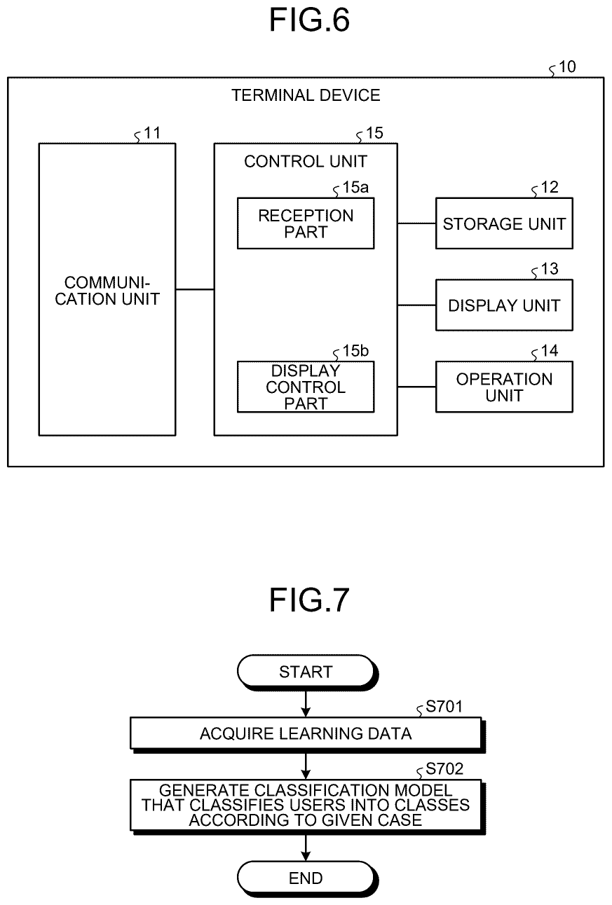

Next, the terminal device 10 according to the embodiment will be described with reference to FIG. 6. FIG. 6 is a diagram illustrating a configuration example of the terminal device 10 according to the embodiment. As illustrated in FIG. 6, the terminal device 10 includes a communication unit 11, a storage unit 12, a display unit 13, an operation unit 14, and a control unit 15.

### (Communication Unit 11)

The communication unit 11 is realized by, for example, an NIC or the like. For example, the communication unit 11 is wirelessly connected to the network N, and transmits and receives information to and from the information processing device 100, for example.

### (Storage Unit 12)

The storage unit 12 is realized by, for example, a semiconductor memory element such as a RAM or a flash memory, or a storage device such as a hard disk or an optical disk. The storage unit 12 may store, for example, information regarding an application installed in the terminal device 10 (e.g., a terminal program or the like according to the embodiment).

### (Display Unit 13)

The display unit 13 is a display screen realized by, for example, a liquid crystal display, an organic electro-luminescence (EL) display, or the like, and is a display device for displaying various types of information. The display unit 13 displays information provided from the information processing device 100 under the control of a display control part 15b.

### (Operation Unit 14)

The operation unit 14 functions as an input unit that receives various operations of a user. The operation unit 14 receives an operation on information displayed by the display unit 13 from a user who uses the terminal device 10.

(Control Unit 15)

The control unit 15 is realized by executing various programs (e.g., the terminal program according to the embodiment) stored in a storage device inside the terminal device 10 by a CPU, an MPU, or the like using a RAM as a work area. In addition, the control unit 15 is realized by, for example, an integrated circuit such as an ASIC or an FPGA.

As illustrated in FIG. 6, the control unit 15 has a reception part 15a and the display control part 15b, and implements or executes a function and an action of information processing to be described below. Note that an internal configuration of the control unit 15 is not limited to the configuration illustrated in FIG. 6, and may be any configuration that performs the information processing to be described later. In addition, a connection relationship of the processing parts included in the control unit 15 is not limited to the connection relationship illustrated in FIG. 6, and may be other connection relationship.

### (Reception Part 15a)

The reception part 15a receives a content transmitted by the provision part 139 of the information processing device 100. For example, the reception part 15a may receive a content determined to be suitable for a user of the terminal device 10 by the analysis part 138 of the information processing device 100. Note that the reception part 15a may request a content from the information processing device 100 in accordance with a user's operation.

### (Display Control Part 15b)

The display control part 15b causes the display unit 13 to display a content received by the reception part 15a. For example, the display control part 15b performs display control so that information presented by the information processing device 100 is displayed in a mode in which a chatbot replies according to input information of a user.

### 8. Model Generation Method

Next, a classification model generation method will be described with reference to FIG. 7. FIG. 7 is a flowchart illustrating a generation processing procedure for generating a classification model.

First, the acquisition part 131 acquires learning data from the learning information database 122 (Step S701). As described above, the learning data may be adjusted in advance by the analysis part 138.

Next, the model generation part 132 generates a classification model that classifies users into classes according to a given case (Step S702). Specifically, the model generation part 132 generates a classification model by using, as learning data, a combination of the label information (fan attribute) applied to the first user and the biological information detected from the first user. For example, when the biological information of the second user is input, the model generation part 132 generates, with respect to each fan attribute corresponding to each predetermined target, a classification model that outputs a probability that the second user belongs to the fan attribute.

### 9. Fan Attribute Estimation Method

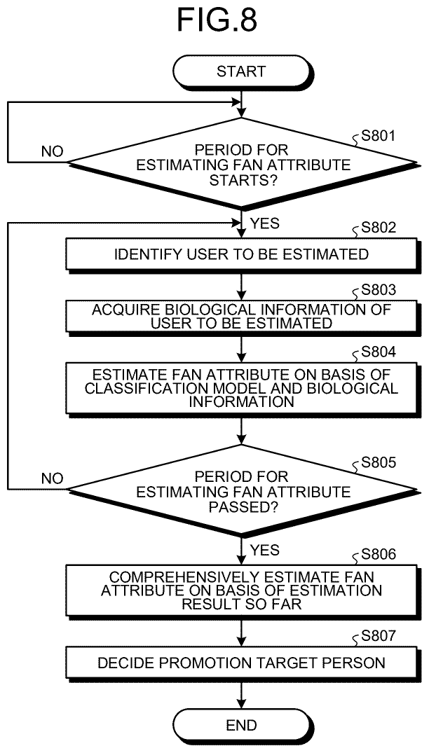

Next, a fan attribute estimation method will be described with reference to FIG. 8. FIG. 8 is a flowchart illustrating an estimation processing procedure for estimating a fan attribute.

First, the estimation part 133 determines whether a period for estimating a fan attribute starts or not (Step S801).

While the period for estimating a fan attribute is yet to start (Step S801; No), the estimation part 133 waits until the period for estimating a fan attribute starts.

On the other hand, in a case where the period for estimating a fan attribute starts (Step S801; Yes), the estimation part 133 identifies an estimation target user whose fan attribute is to be estimated (Step S802). For example, the estimation part 133 may identify a user who has come to a venue of the event EV or a user who views the event EV remotely as a user to be estimated. For example, the estimation part 133 may identify, as a user to be estimated, a user having a terminal device 10 whose connection is established with the information processing device 100.

Next, the acquisition part 131 acquires biological information of the user to be estimated (Step S803). For example, the acquisition part 131 acquires, as the biological information, sensor information (e.g., heart rate, myoelectric potential, body temperature, and the like) detected in real time by a sensor worn by the user to be estimated or a sensor provided in the terminal device 10 of the user to be estimated.

Then, the estimation part 133 estimates a fan attribute on the basis of the classification model generated by the model generation part 132 and the biological information of the user to be estimated (Step S804). For example, the estimation part 133 inputs the biological information of the second user to the classification model. Then, the estimation part 133 estimates to which target fan attribute the user belongs among the three types of fan attributes, the official fan, the potential fan, and the non-fan, on the basis of the output probability.

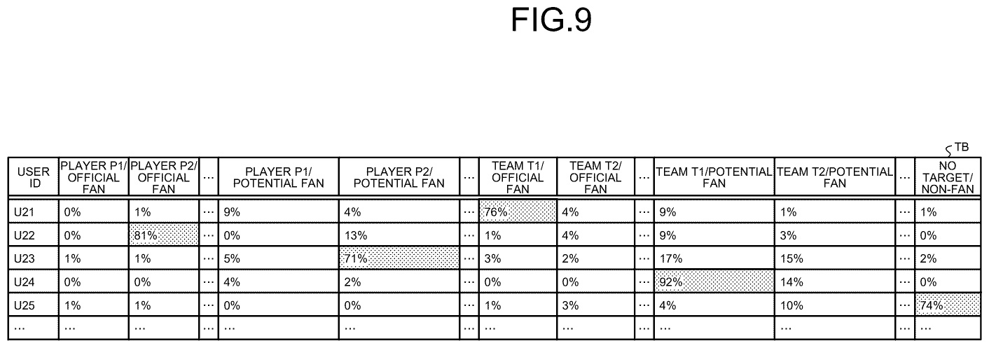

Here, a method of estimating a fan attribute on the basis of the probability output by the classification model will be described with reference to FIG. 9. FIG. 9 is a diagram illustrating an example of a method of estimating a fan attribute from an output result by the classification model.

FIG. 9 illustrates a list table TB indicating a probability of being each fan attribute defined for each target (player or team), such as “player P1/official fan”, “player P2/official fan”, “player P1/potential fan”, “player P2/potential fan”, “team T1/official fan”, “team T2/official fan”, “team T1/potential fan”, “team T2/potential fan”, and “no target/non-fan”.

For this reason, the table TB indicates that the classification model of outputting the probability of being each fan attribute defined for each target is generated, with the biological information of the user to be estimated as an input.

For example, according to the table TB, “0%” is input between a user ID “U21” and “player P1/official fan”. Such an example means that the classification model has output “0%” as the probability that the user U21 is the “official fan of the player P1” in response to input of the biological information of the user U21.

In addition, “76%” is input between the user ID “U21” and the “team T1/official fan”. Such an example means that the classification model has output “76%” as the probability that the user U21 is the “official fan of the team T1” in response to the input of the biological information of the user U21. Then, according to the table TB, this “76%” is the highest numerical value among the probabilities corresponding to the user U21. Thus, the estimation part 133 estimates that the fan attribute of the user U21 is “official fan” targeting the team T1.

In addition, “81%” is input between a user ID “U22” and “player P2/official fan”. Such an example means that the classification model has output “81%” as the probability that the user U22 is the “official fan of the player P2” in response to input of the biological information of the user U22. Then, according to the table TB, this “81%” is the highest numerical value among the probabilities corresponding to the user U22. Thus, the estimation part 133 estimates that the fan attribute of the user U22 is “official fan” targeting the player P2.

Since the users U23 to U25 can also be described after the above example, detailed description of these users in FIG. 9 is omitted.

Returning to FIG. 8, next, the estimation part 133 determines whether or not the period for estimating a fan attribute has ended (Step S805).

In a case where the period for estimating a fan attribute is yet to be ended (Step S805; No), the estimation part 133 shifts the processing to Step S802.

On the other hand, when the period for estimating a fan attribute has ended (Step S805; Yes), the estimation part 133 comprehensively estimates a fan attribute on the basis of the estimation results so far (Step S806). For example, since the estimation part 133 estimates a fan attribute a plurality of times per user to be estimated, a fan attribute may be comprehensively determined from estimation results of the plurality of times.

For example, it is assumed that for a certain user, the estimation part 133 obtains estimation results of “official fan of team T1” as the first time result, “official fan of team T1” as the second time result, “official fan of team T1” as the third time result, and “potential fan of team T2” as the fourth time result. In such a case, the estimation part 133 may recognize that the fourth estimation result is an abnormal value, and determine whether the fourth estimation result is correct or not by combining the profile information. For example, in a case where the fourth estimation result is different from a fan attribute estimated from the profile information, the estimation part 133 may determine that the fourth estimation result is noise and remove it. Therefore, in such an example, the estimation part 133 may comprehensively estimate the user as “official fan of team T1” from the first to third estimation results.

In addition, the processing control part 134 decides a promotion target person on the basis of the final estimation result obtained in Step S806 (Step S807). Specifically, in a case where there is a user estimated to be a potential fan as a fan attribute among users to be estimated, the processing control part 134 defines the user as a promotion target person who is encouraged to make an attribute transition from a potential fan to an official fan. In addition, in a case where there is a user estimated to be a non-fan as a fan attribute among the users to be estimated, the processing control part 134 defines the user as a promotion target person who is encouraged to make an attribute transition from a non-fan to an official fan.

Then, the processing control part 134 executes associating processing for associating the user defined as the promotion target person and the official fan user. A method of the associating processing will be described with reference to FIGS. 10 to 12.

Note that in FIG. 8, the period for estimating a fan attribute may be a plurality of specific estimation periods provided in a long period from predetermined timing (e.g., a predetermined time before a venue time) before the event EV is held to the end of the event EV. Examples of the estimation period are possibly patterns such as a period from “zero minute before the start of the event EV to one minute after the start of the event EV”, a period from “ten minutes after the start of the event EV to 11 minutes after the start of the event EV”, and a period from “20 minutes after the start of the event EV to 21 minutes after the start of the event EV”. In addition, although according to such an example, a blank period in which the estimation processing is not performed occurs, in this period, information processing corresponding to the fanization promotion function or the experience improvement function may be performed.

### 10. Associating Method

Next, an associating method of associating an official fan user and a promotion target person will be described with reference to FIGS. 10 to 12.

### [10-1. Associating Method (1)]

First, a mode of the associating method of associating an official fan user and a potential fan user will be described with reference to FIG. 10. FIG. 10 is a diagram illustrating an example (1) of the associating method.

First, as a result of the estimation processing by the estimation part 133, it is assumed that there is a user estimated to be a “potential fan” targeting the player P1 (a potential fan user of the player P1) as a fan attribute among the users Ux. In such a case, the processing control part 134 searches for an official fan user having a common target with the potential fan user of the player P1 among the official fan users. Specifically, the processing control part 134 searches for a user estimated to be an “official fan” targeting the player P1 (official fan user of the player P1) as a fan attribute.

Then, in a case where there is an official fan user of the player P1, the processing control part 134 associates the official fan user of the player P1 with the potential fan user of the player P1 as illustrated in FIG. 10.

Note that in a case where there are a plurality of official fan users of the player P1, the processing control part 134 refers to, for example, the table TB of FIG. 9 and extracts a user having the highest probability of being an “official fan of the player P1” among the official fan users of the player P1. Then, the processing control part 134 may associate the extracted user with the potential fan user of the player P1.

In addition, as a result of the estimation processing by the estimation part 133, it is assumed that there is a user estimated to be a “potential fan” targeting the team T1 (a potential fan user of the team T1) as a fan attribute among the users Ux. In such a case, the processing control part 134 searches for an official fan user having a common target with the potential fan user of the team T1 among the official fan users. Specifically, the processing control part 134 searches for a user estimated to be an “official fan” targeting the team T1 (official fan user of the team T1) as a fan attribute.

Then, in a case where there is an official fan user of the team T1, the processing control part 134 associates the official fan user of the team T1 with the potential fan user of the team T1 as illustrated in FIG. 10.

In addition, in a case where there are a plurality of official fan users of the team T1, the processing control part 134 similarly refers to the table TB of FIG. 9 and extracts a user having the highest probability of being an “official fan of the team T1” among the official fan users of the team T1. Then, the processing control part 134 may associate the extracted user with the potential fan user of the team T1.

Description of other cases in FIG. 10 is omitted.

### [10-2. Associating Method (2)]

Next, a mode of an associating method as a countermeasure in a case where associating with an official fan user is impossible will be described with reference to FIG. 11. FIG. 11 is a diagram illustrating an example (2) of the associating method.

Also in the example of FIG. 11, it is assumed that there is a potential fan user of the player P1 among the users Ux. In such a case, the processing control part 134 searches for an official fan user having a common target with the potential fan user of the player P1 among the official fan users as described with reference to FIG. 10. In other words, the processing control part 134 searches for an official fan user of the player P1.

Here, when no official fan user of the player P1 is present, the processing control part 134 cannot associate an official fan user and a potential fan user, with the player P1 as a trigger. In such a case, the processing control part 134 specifies high-order targets including the player P1. For example, the processing control part 134 can specify the team T1 to which the player P1 belongs as a high-order target. As a result, as illustrated in FIG. 11, the processing control part 134 may redefine a promotion target person by estimating that a potential fan user of the player P1 is also a “potential fan” targeting the team T1.

In such a state, the processing control part 134 searches for an official fan user having a common target with the potential fan user of the team T1 among the official fan users. Specifically, the processing control part 134 searches for a user estimated to be an “official fan” targeting the team T1 (official fan user of the team T1) as a fan attribute.

Then, in a case where there is an official fan user of the team T1, the processing control part 134 associates the official fan user of the team T1 with the potential fan user of the team T1 as illustrated in FIG. 11.

### [10-3. Associating Method (3)]

Next, a mode of an associating method of associating an official fan user and a non-fan user will be described with reference to FIG. 12. FIG. 12 is a diagram illustrating an example (3) of the associating method.

First, it is assumed that as a result of the estimation processing by the estimation part 133, there is a non-fan user estimated to be a neutral “non-fan”, which is neither an official fan nor a potential fan of any target, as a fan attribute among the users Ux. In such a case, the processing control part 134 searches for a strongly reactive user having the highest value of the biological information (e.g., heart rate, myoelectric potential, and the like) and showing a strong reaction in the event EV among the official fan users.

Then, when there is a strongly reactive user, the processing control part 134 associates the strongly reactive user with a non-fan user as illustrated in FIG. 12.

### 11. Fanization Promotion Method

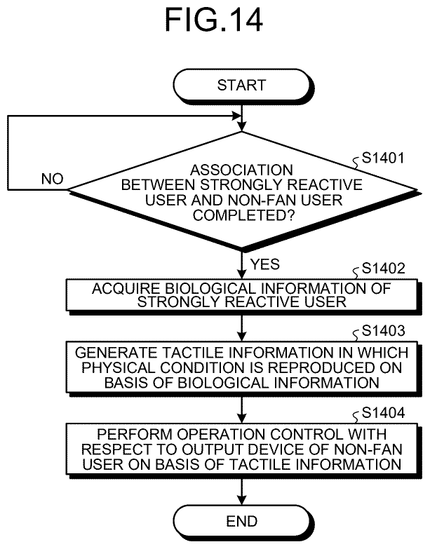

Next, with reference to FIGS. 13 and 14, a fanization promotion method of prompting a transition of a fan attribute (potential fan or non-fan) of the promotion target person to an official fan will be described.

### [11-1. Fanization Promotion Method (1)]

First, with reference to FIG. 13, a fanization promotion method performed for a potential fan user among users defined as promotion target persons will be described. FIG. 13 is a flowchart (1) illustrating a procedure of the fanization promotion processing.

First, the tactile information generation part 135 determines whether or not association between an official fan user and a potential fan user has been completed (Step S1301). While the association is yet to be completed (Step S1301; No), the tactile information generation part 135 waits until the association is completed.

On the other hand, in a case where the association is completed (Step S1301; Yes), the tactile information generation part 135 acquires biological information sensed in real time for the official fan user (Step S1302).

In the following, among the examples illustrated in FIG. 10, the case where an official fan user of the player P1 and a potential fan user of the player P1 are associated with each other will be described as an example. In such an example, the tactile information generation part 135 acquires biological information sensed in real time for the official fan user of the player P1.

Then, the tactile information generation part 135 generates tactile information in which a physical condition of the official fan user of the player P1 is reproduced on the basis of the biological information of the official fan user of the player P1 (Step S1303). For example, the tactile information generation part 135 may generate, as the tactile information, vibration information according to a heart rate variation of an official fan user, pressure-sensitive information according to a contraction state of a muscle (e.g., wrist muscle) of the official fan user, and thermal sensation information according to a body temperature (e.g., a temperature of a palm) of the official fan user.

In addition, the first output control part 136 performs operation control so that an output device worn by the potential fan user of the player P1 operates in a mode corresponding to the tactile information generated in Step S1303 (Step S1304).

### [11-2. Fanization Promotion Method (2)]

Next, a fanization promotion method performed for a non-fan user among users defined as promotion target persons will be described with reference to FIG. 14. FIG. 14 is a flowchart (2) illustrating a procedure of the fanization promotion processing.

Using the example of FIG. 12, first, the tactile information generation part 135 determines whether or not association between a strongly reactive user among the official fan users and a non-fan user has been completed (Step S1401). While the association is yet to be completed (Step S1401; No), the tactile information generation part 135 waits until the association is completed.

On the other hand, in a case where the association is completed (Step S1401; Yes), the tactile information generation part 135 acquires biological information sensed in real time for the strongly reactive user (Step S1402).

Then, the tactile information generation part 135 generates tactile information in which a physical condition of a non-fan user is reproduced on the basis of the biological information of the strongly reactive user (Step S1403). For example, the tactile information generation part 135 may generate, as the tactile information, vibration information according to a heart rate variation of a strongly reactive user, pressure-sensitive information according to a contraction state of a muscle (e.g., wrist muscle) of the strongly reactive user, and thermal sensation information according to a body temperature (e.g., a temperature of a palm) of the strongly reactive user.

In addition, the first output control part 136 performs operation control so that an output device worn by the non-fan user operates in a mode corresponding to the tactile information generated in Step S1403 (Step S1404).

Here, the example of FIG. 14 illustrates an example in which the tactile information generation part 135 generates tactile information on the basis of biological information actually detected from an official fan user. However, since the biological information is easily affected by a physical condition, in a case, for example, where an official fan user has a bad physical condition, tactile information appropriately reflecting excitement and tension of the official fan user may not be generated in some cases.

Therefore, the tactile information generation part 135 may statistically estimate a physical condition (e.g., biological information when a physical condition is good) of the official fan user without using the biological information actually detected from the official fan user, and generate tactile information in which the estimated physical condition is reproduced.

### 12. Fan Experience Improvement Method

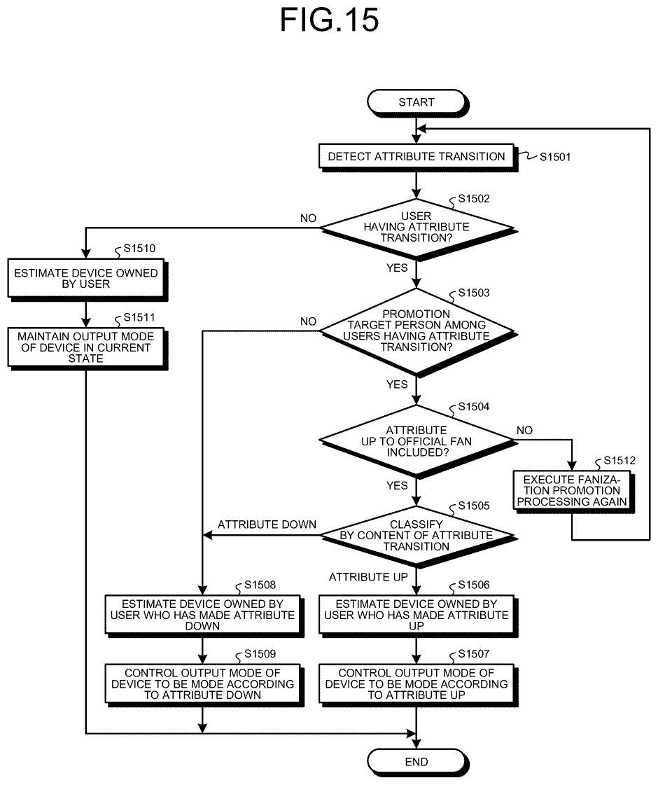

Next, a method of improving a fan experience will be described with reference to FIG. 15. FIG. 15 is a flowchart illustrating a procedure of fan experience improvement processing.

First, the second output control part 137 detects whether or not the user Ux has made an attribute transition from the current fan attribute to other fan attribute (Step S1501).

Then, the second output control part 137 determines whether or not there is a user whose attribute transition has been detected among the users Ux on the basis of the detection result (Step S1502).

In a case where there is a user whose attribute transition is detected among the users Ux (Step S1502; Yes), the second output control part 137 determines whether or not there is a user who is a promotion target person among the users whose attribute transition has been detected (Step S1503).

In a case where there exists a user who is a promotion target person among the users whose attribute transition has been detected (Step S1503; Yes), the second output control part 137 determines whether or not the attribute transition includes an attribute transition to an official fan (i.e., attribute up) (Step S1504).

In a case where the attribute transition detected from the promotion target person includes the attribute up (Step S1504; Yes), the second output control part 137 classifies the promotion target person by a content of the attribute transition detected with respect to the promotion target person (Step S1505). Specifically, the second output control part 137 classifies users who are promotion target persons into a user having an attribute transition to an official fan (i.e., the attribute up) and a user having an attribute transition to a non-fan (i.e., the attribute down).

The second output control part 137 extracts the user classified as the attribute up (Step S1505; attribute up), and estimates a device for the event EV owned by the extracted user (Step S1506). Examples of the device for the event EV include a penlight and a light emission wristband. Therefore, the second output control part 137 estimates an individual device owned by the user who has made attribute up to an official fan among the devices for the event EV on the basis of a purchase history related to the event EV.

Then, the second output control part 137 controls an output mode of the estimated device according to the attribute up (Step S1507). For example, the second output control part 137 may increase a light emission intensity of the device according to the attribute up.

On the other hand, the second output control part 137 extracts the user classified as the attribute down (Step S1505; attribute down), and estimates a device for the event EV owned by the extracted user (Step S1508). For example, the second output control part 137 estimates an individual device owned by the user who has made attribute down among the devices for the event EV on the basis of the purchase history related to the event EV.

Then, the second output control part 137 controls an output mode of the estimated device according to the attribute down (Step S1509). For example, the second output control part 137 may decrease a light emission intensity of the device according to the attribute down.

On the other hand, the case where a user who is a promotion target person is not present among users whose attribute transitions have been detected (Step S1503; No) represents that an official fan user has made attribute down to a potential fan or to a non-fan. For this reason, when proceeding to Step S1503; No, the second output control part 137 extracts a user who has made attribute down from an official fan, and causes the processing to proceed to Step S1508.

In addition, in a case where a user whose attribute transition has been detected is not present among the users Ux (Step S1502; No), the second output control part 137 estimates a device for the event EV owned by the user Ux (Step S1510). For example, the second output control part 137 estimates an individual device owned by the user Ux among the devices for the event EV on the basis of the purchase history related to the event EV.

Then, the second output control part 137 performs control so that the estimated device maintains a current state without changing an output mode (Step S1511).

In addition, in a case where the attribute transitions detected for the promotion target persons do not include an attribution up (Step S1504; No), the second output control part 137 may determine that the promotion for the attribute up was insufficient, and cause the fanization promotion processing described in FIGS. 13 and 14 to be executed again (Step S1512).

Here, FIG. 15 illustrates the example in which the second output control part 137 controls the output mode of the device for the event EV according to a transition state of a fan attribute. However, the second output control part 137 is not limited to a device for the event EV, and may control output modes of various devices.

For example, a large monitor may be installed in a venue of the event EV, and the second output control part 137 may control a display mode on the large monitor. For example, image information (e.g., an avatar or the like) indicating each user Ux may be displayed on a large monitor in a state of belonging to any one of three groups, an official fan group, a potential fan group, and a non-fan group. In such a case, the second output control part 137 may perform control to move the image information from, for example, the potential fan group to the official fan group according to a transition state of a fan attribute.

### 13. Example of Hardware Configuration

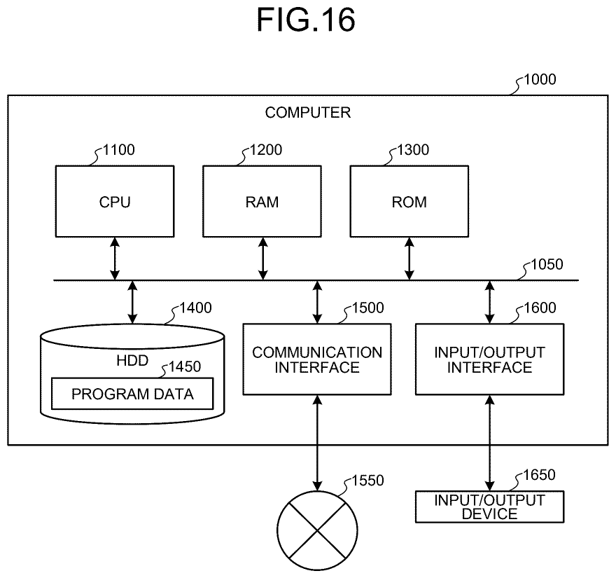

An example of a hardware configuration of a computer corresponding to a device such as the information processing device 100 or the terminal device 10 according to the above-described embodiment will be described with reference to FIG. 16. FIG. 16 is a block diagram illustrating the example of the hardware configuration of the computer corresponding to the device according to the embodiment of the present disclosure. Note that FIG. 16 illustrates an example of the hardware configuration of the computer corresponding to the device according to the embodiment of the present disclosure, and is not necessarily limited to the configuration illustrated in FIG. 16.

As illustrated in FIG. 16, a computer 1000 has a central processing unit (CPU) 1100, a random access memory (RAM) 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops the program stored in the ROM 1300 or in the HDD 1400 into the RAM 1200, and executes processing corresponding to various programs.

The ROM 1300 stores a boot program such as a basic input output system (BIOS) executed by the CPU 1100 when the computer 1000 is activated, a program depending on the hardware of the computer 1000, and the like.

The HDD 1400 is a computer-readable recording medium that non-transiently records a program executed by the CPU 1100, data for use by the program, and the like. Specifically, the HDD1400 records program data 1450. The program data 1450 is an example of an information processing program for realizing the information processing method according to the embodiment of the present disclosure, and data for use by the information processing program.

The communication interface 1500 is an interface for the computer 1000 to connect to an external network 1550 (e.g., the Internet). For example, the CPU 1100 receives data from other apparatus or transmits data generated by the CPU 1100 to other apparatus via the communication interface 1500.

The input/output interface 1600 is an interface for connecting an input/output device 1650 and the computer 1000. For example, the CPU 1100 receives data from an input device such as a keyboard or a mouse via the input/output interface 1600. In addition, the CPU 1100 transmits data to an output device such as a display device, a speaker, or a printer via the input/output interface 1600. In addition, the input/output interface 1600 may function as a media interface that reads a program or the like recorded in a predetermined recording medium (media). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the device according to the embodiment of the present disclosure (as an example, the information processing device 100), the CPU 1100 of the computer 1000 implements the virous processing functions to be executed by each part of the control unit 130 illustrated in FIG. 3 by executing the information processing program loaded on the RAM 1200. In other words, the CPU1100, the RAM1200, and the like implement the information processing method by the device (as an example, the information processing device 100) according to the embodiment of the present disclosure in cooperation with software (the information processing program loaded on the RAM 1200).

In addition, in a case where the computer 1000 functions as the device according to the embodiment of the present disclosure (as an example, the terminal device 10), the CPU 1100 of the computer 1000 implements the virous processing functions to be executed by each part of the control unit 15 as illustrated in FIG. 6 by executing a terminal program loaded on the RAM 1200. In other words, the CPU1100, the RAM1200, and the like implement the information processing method by the device (as an example, the terminal device 10) according to the embodiment of the present disclosure in cooperation with software (a terminal program loaded on the RAM 1200).

### 14. Conclusion

Although the embodiment of the present disclosure has been described in the foregoing, the technical scope of the present disclosure is not limited to the above-described embodiment as it is, and various modifications can be made without departing from the gist of the present disclosure. In addition, components of the embodiment and the modification may be appropriately combined. For example, the processing described as being executed by the information processing device 100 may be performed by the terminal device 10. In other words, in one aspect of the present disclosure, a configuration in which the terminal device 10 acts as the information processing device according to the embodiment may be adopted.

In addition, the effects described in the embodiment recited in the present specification are examples only and are not limited, and other effects may be provided.

Note that the present technique can also have the following configurations.

(1) An information processing device comprising:
an estimation part that estimates, on the basis of context information of a first user, a fan type to which a second user belongs among fan types that are types defined for each of predetermined targets, and are types defined in stages according to degrees of supporting the predetermined target; and
a control unit that executes, for the second user, control according to a fan type estimated by the estimation part.

(2) The information processing device according to the above (1), wherein
the fan types include a first fan type indicating being an official fan of any of the predetermined targets, a second fan type indicating being a potential fan of any of the predetermined targets, and a third fan type indicating not being any fan of any of the predetermined targets, and
the estimation part estimates a fan type to which the second user belongs among the first fan type, the second fan type, and the third fan type defined for each of the predetermined targets.

(3) The information processing device according to the above (2), further comprising:
a model generation part that generates a model for estimating a fan type to which the second user belongs by using a combination of a correct answer label indicating a fan type to which the first user belongs and biological information of the first user as learning data, wherein
the estimation part estimates a fan type to which the second user belongs among the first fan type, the second fan type, and the third fan type defined for each of the predetermined targets on the basis of the model and biological information of the second user.

(4) The information processing device according to the above (3), wherein
the model generation part generates the model that outputs a probability that the second user belongs to each fan type corresponding to each of the predetermined targets, with the biological information of the second user as an input, and
the estimation part estimates, on the basis of the probability, to which of the first fan type, the second fan type, and the third fan type the second user belongs, the first fan type, the second fan type, and the third fan type being defined for each of the predetermined targets.

(5) The information processing device according to the above (2), wherein
in a case where there is a user estimated to have the second fan type among the second users, the control unit defines the user as a promotion target person who is to be encouraged to make an attribute change from the second fan type to the first fan type.

(6) The information processing device according to the above (5), wherein
the control unit associates a fan user who is a user, among the second users, estimated to have the first fan type that is an official fan of the predetermined target indicated by the fan type of the promotion target person, with the promotion target person.

(7) The information processing device according to the above (6), wherein
in a case where there are a plurality of the fan users, the control unit associates a user having a highest probability of belonging to the first fan type among the fan users with the promotion target person.

(8) The information processing device according to the above (6), wherein
in a case where the fan user is not present and the association of the fan user with the promotion target person is impossible, the control unit redefines, as the promotion target person, the second user who has been estimated to have the second fan type as a fan type corresponding to high-order targets including the predetermined target indicated by the fan type of the promotion target person.

(9) The information processing device according to the above (2), wherein
in a case where there is a user estimated to have the third fan type among the second users, the control unit defines the user as a promotion target person who is to be encouraged to make an attribute change from the third fan type to the first fan type.

(10) The information processing device according to the above (9), wherein
the control unit associates a fan user, among the second users, who is a user estimated to have the first fan type and having highest-order biological information detected, with the promotion target person.

(11) The information processing device according to the above (6), wherein
the control unit performs control to present fanization promotion information to the promotion target person, the fanization promotion information being information for the purpose of encouraging a change of an attribute of the promotion target person to the first fan type.

(12) The information processing device according to the above (11), further comprising:
a tactile information generation part that generates tactile information indicating a physical condition of the fan user; and
a first output control part that performs control so that the tactile information is output from an output device worn by the promotion target person as the fanization promotion information.

(13) The information processing device according to the above (12), wherein
the tactile information generation part generates tactile information in which a physical condition is reproduced on the basis of biological information detected from the fan user.

(14) The information processing device according to the above (12), wherein
the tactile information generation part generates tactile information in which a physical condition statistically estimated for the fan user is reproduced.

(15) The information processing device according to the above (12), wherein
the tactile information generation part generates, as the tactile information, any one of vibration information for making a user feel vibration according to heart rate variation of the fan user, pressure-sensitive information for making a user feel a pressure according to a myoelectric potential of the fan user, and thermal sensation information for making a user feel a body temperature of the fan user.

(16) The information processing device according to the above (1), wherein
in a case where an attribute change has been detected from a current fan type to other fan type by continuous estimation of a fan type, the control unit performs control so that additional information for the purpose of adding a value to an experience of a user whose attribute change has been detected is presented.

(17) The information processing device according to the above (16), further comprising:
a second output control part that controls, as presentation control of the additional information, an output mode in a predetermined device corresponding to the user whose attribute change has been detected according to the attribute change.

(18) The information processing device according to the above (17), wherein
the second output control part estimates a device owned by the user among the predetermined devices, and controls an output mode of the estimated device according to the attribute change.

(19) The information processing device according to the above (1), further comprising:
a provision part that provides, on the basis of an analysis result obtained by analyzing the context information, a content according to the analysis result to a user from which the context information has been acquired.

(20) An information processing method executed by an information processing device, the method comprising:
an estimation step of estimating, on the basis of context information of a first user, a fan type to which a second user belongs among fan types that are types defined for each of predetermined targets, and are types defined in stages according to degrees of supporting the predetermined target; and
a control step of executing, for the second user, control according to a fan type estimated by the estimation step.

(21) An information processing program for causing an information processing device to execute:
an estimation procedure of estimating, on the basis of context information of a first user, a fan type to which a second user belongs among fan types that are types defined for each of predetermined targets, and are types defined in stages according to degrees of supporting the predetermined target; and
a control procedure of executing, for the second user, control according to a fan type estimated by the estimation procedure.

(22) A terminal device that communicates with an information processing device including:
an estimation part that estimates, on the basis of context information of a first user, a fan type to which a second user belongs among fan types that are types defined for each of predetermined targets, and are types defined in stages according to degrees of supporting the predetermined targets; and
a control unit that executes, for the second user, control according to a fan type estimated by the estimation part,
the terminal device being for use by the second user, and comprising:
a reception part that receives information provided from the information processing device according to control by the control unit; and
a display control part that causes the information received by the reception part to be display on a screen.

### REFERENCE SIGNS LIST

1 SYSTEM
10 TERMINAL DEVICE
11 COMMUNICATION UNIT
12 STORAGE UNIT
13 DISPLAY UNIT
14 OPERATION UNIT
15 CONTROL UNIT
15a RECEPTION PART
15b DISPLAY CONTROL PART
100 INFORMATION PROCESSING DEVICE
110 COMMUNICATION UNIT
120 STORAGE UNIT
121 PROFILE INFORMATION DATABASE
122 LEARNING INFORMATION DATABASE
123 SENSOR INFORMATION DATABASE
124 ESTIMATION RESULT DATABASE
125 ASSOCIATION INFORMATION DATABASE
130 CONTROL UNIT
131 ACQUISITION PART
132 MODEL GENERATION PART
133 ESTIMATION PART
134 PROCESSING CONTROL PART
135 TACTILE INFORMATION GENERATION PART
136 FIRST OUTPUT CONTROL PART
137 SECOND OUTPUT CONTROL PART
138 ANALYSIS PART
139 PROVISION PART

1. An information processing device comprising:
an estimation part that estimates, on the basis of context information of a first user, a fan type to which a second user belongs among fan types that are types defined for each of predetermined targets, and are types defined in stages according to degrees of supporting the predetermined target; and
a control unit that executes, for the second user, control according to a fan type estimated by the estimation part.

2. The information processing device according to claim 1, wherein
the fan types include a first fan type indicating being an official fan of any of the predetermined targets, a second fan type indicating being a potential fan of any of the predetermined targets, and a third fan type indicating not being any fan of any of the predetermined targets, and
the estimation part estimates a fan type to which the second user belongs among the first fan type, the second fan type, and the third fan type defined for each of the predetermined targets.

3. The information processing device according to claim 2, further comprising:
a model generation part that generates a model for estimating a fan type to which the second user belongs by using a combination of a correct answer label indicating a fan type to which the first user belongs and biological information of the first user as learning data, wherein
the estimation part estimates a fan type to which the second user belongs among the first fan type, the second fan type, and the third fan type defined for each of the predetermined targets on the basis of the model and biological information of the second user.

4. The information processing device according to claim 3, wherein
the model generation part generates the model that outputs a probability that the second user belongs to each fan type corresponding to each of the predetermined targets, with the biological information of the second user as an input, and
the estimation part estimates, on the basis of the probability, to which of the first fan type, the second fan type, and the third fan type the second user belongs, the first fan type, the second fan type, and the third fan type being defined for each of the predetermined targets.

5. The information processing device according to claim 2, wherein
in a case where there is a user estimated to have the second fan type among the second users, the control unit defines the user as a promotion target person who is to be encouraged to make an attribute change from the second fan type to the first fan type.

6. The information processing device according to claim 5, wherein
the control unit associates a fan user who is a user, among the second users, estimated to have the first fan type that is an official fan of the predetermined target indicated by the fan type of the promotion target person, with the promotion target person.

7. The information processing device according to claim 6, wherein
in a case where there are a plurality of the fan users, the control unit associates a user having a highest probability of belonging to the first fan type among the fan users with the promotion target person.

8. The information processing device according to claim 6, wherein
in a case where the fan user is not present and the association of the fan user with the promotion target person is impossible, the control unit redefines, as the promotion target person, the second user who has been estimated to have the second fan type as a fan type corresponding to high-order targets including the predetermined target indicated by the fan type of the promotion target person.

9. The information processing device according to claim 2, wherein
in a case where there is a user estimated to have the third fan type among the second users, the control unit defines the user as a promotion target person who is to be encouraged to make an attribute change from the third fan type to the first fan type.

10. The information processing device according to claim 9, wherein
the control unit associates a fan user, among the second users, who is a user estimated to have the first fan type and having highest-order biological information detected, with the promotion target person.

11. The information processing device according to claim 6, wherein
the control unit performs control to present fanization promotion information to the promotion target person, the fanization promotion information being information for the purpose of encouraging a change of an attribute of the promotion target person to the first fan type.

12. The information processing device according to claim 11, further comprising:
a tactile information generation part that generates tactile information indicating a physical condition of the fan user; and
a first output control part that performs control so that the tactile information is output from an output device worn by the promotion target person as the fanization promotion information.

13. The information processing device according to claim 12, wherein
the tactile information generation part generates tactile information in which a physical condition is reproduced on the basis of biological information detected from the fan user.

14. The information processing device according to claim 12, wherein
the tactile information generation part generates tactile information in which a physical condition statistically estimated for the fan user is reproduced.

15. The information processing device according to claim 12, wherein
the tactile information generation part generates, as the tactile information, any one of vibration information for making a user feel vibration according to heart rate variation of the fan user, pressure-sensitive information for making a user feel a pressure according to a myoelectric potential of the fan user, and thermal sensation information for making a user feel a body temperature of the fan user.

16. The information processing device according to claim 1, wherein
in a case where an attribute change has been detected from a current fan type to other fan type by continuous estimation of a fan type, the control unit performs control so that additional information for the purpose of adding a value to an experience of a user whose attribute change has been detected is presented.

17. The information processing device according to claim 16, further comprising:
a second output control part that controls, as presentation control of the additional information, an output mode in a predetermined device corresponding to the user whose attribute change has been detected according to the attribute change.

18. The information processing device according to claim 17, wherein
the second output control part estimates a device owned by the user among the predetermined devices, and controls an output mode of the estimated device according to the attribute change.

19. The information processing device according to claim 1, further comprising:
a provision part that provides, on the basis of an analysis result obtained by analyzing the context information, a content according to the analysis result to a user from which the context information has been acquired.

20. An information processing method executed by an information processing device, the method comprising:
an estimation step of estimating, on the basis of context information of a first user, a fan type to which a second user belongs among fan types that are types defined for each of predetermined targets, and are types defined in stages according to degrees of supporting the predetermined target; and
a control step of executing, for the second user, control according to a fan type estimated by the estimation step.

21. An information processing program for causing an information processing device to execute:
an estimation procedure of estimating, on the basis of context information of a first user, a fan type to which a second user belongs among fan types that are types defined for each of predetermined targets, and are types defined in stages according to degrees of supporting the predetermined target; and
a control procedure of executing, for the second user, control according to a fan type estimated by the estimation procedure.

22. A terminal device that communicates with an information processing device including:
an estimation part that estimates, on the basis of context information of a first user, a fan type to which a second user belongs among fan types that are types defined for each of predetermined targets, and are types defined in stages according to degrees of supporting the predetermined targets; and
a control unit that executes, for the second user, control according to a fan type estimated by the estimation part,
the terminal device being for use by the second user, and comprising:
a reception part that receives information provided from the information processing device according to control by the control unit; and
a display control part that causes the information received by the reception part to be display on a screen.
